(19) United States
(12) Patent Application Publication
(10) Pub. No.: US 2009/0235319 A1
(43) Pub. Date: Sep. 17, 2009

(54) Video on Demand Gateway

(75) Inventors: Weidong Mao, West Windsor, NJ (US); Venu Krishnamoorthy, Bensalem, PA (US); Michael Newman, New Hope, PA (US); Aongus Flood, Narberth, PA (US)

Correspondence Address: BANNER & WITCOFF , LTD;ATTORNEYS FOR CLIENT NUMBER 007412, 1100 13th STREET, N.W., SUITE 1200, WASHINGTON, DC, 20005-4051, US

(73) Assignee: TVWorks, LLC, Philadelphia, PA (US)

(21) Appl. No.: 12/470,930

(22) Filed: May 22, 2009

Related U.S. Application Data
(63) Continuation of application No. 10/010,719, filed on Nov. 8, 2001.

(51) Int. Cl. H04N 7/173

(52) U.S. Cl. 725/93; 725/87

(57) ABSTRACT

A video on demand (VOD) gateway allows multiple incompatible and non-interoperable VOD systems to function as a single unified VOD system. A VOD gateway system includes a VOD asset gateway, a VOD session gateway, a VOD transaction gateway and a generic VOD client software program. The generic VOD client software resides in a CATV set-top box. The VOD asset gateway at the headend aggregates video inventory from multiple VOD vendor's equipment. The VOD session gateway at the headend translates a subscriber request in a generic protocol for VOD program into the proprietary protocol for a specific VOD system. The VOD transaction gateway at the headend aggregates embodiment, a VOD gateway permits operators of multiple CATV systems to use multiple incompatible and non-interoperable VOD systems in each plurality of separate CATV systems.

This is a continuation patent application of U.S. patent application Ser. No. 10/010,719 entitled “Video On Demand Gateway” filed Nov. 8, 2001, for which priority is claimed and the contents of which are incorporated herein in its entirety.

### FIELD OF THE INVENTION

This invention relates to the field of video on demand (VOD) systems.

### BACKGROUND OF THE INVENTION

A video on demand service permits a viewer to order a movie or other video program material for immediate viewing. In a typical broadcast satellite or cable television (CATV) system, the viewer is presented with a library of video choices. The VOD program material, such as for example movies, are referred to herein as assets, VOD assets or video assets. The viewer can search for desired videos by sorting the library according to actor, title, genre or other criteria before making a selection. More generally, assets include audio files, images and/or text.

In a true VOD system, a portion of the CATV spectrum is dedicated (on a per use basis) to transmit the requested video to the subscriber. The practice of assigning a portion of the CATV spectrum on a temporary basis is known as narrowcasting. Since the assigned video channel is dedicated to one viewer, VCR-like commands are possible. That is, for example, the purchased video may be paused, fast-forwarded, rewound or played in slow motion. Various vendors, known as VOD suppliers, provide systems and software that enable CATV operators to offer a VOD service to their subscribers.

In a typical VOID system, a software component (known as the VOD client) resides in the CATV set-top box (STB) at the viewer's home. A typical VOD system further includes a VOD server at the CATV system headend and a VOD pump. The VOD pump is a source of video signal. A common form of video signal is a digital MPEG stream. In addition to a VOD pump, a typical VOD system includes a VOD asset management system and a VOD business management system.

The VOD asset management system generates lists of movies that are available for VOD purchase. The VOD client communicates requests to the VOD management system at the CATV headend and sets up the VOD pump to transmit the movie to the viewer. Also, for billing purposes, the VOD business management system records the event of a video purchase and communicates the purchase event to a billing system through which the viewer pays for the video purchase.

The VOD server is a memory intensive system that stores the video library (video assets) at the headend and generates the VOD video stream for each subscriber. The video inventory in the VOD server may contain thousands of titles. The VOD server further generates one VOD video stream for each active VOD viewer. There may be thousands of simultaneous active VOD viewers.

As the video library expands, and as the number of VOD customers grows, the memory requirements and transmitting capacity of the VOD server is increased. Expansion of the VOD service means that the CATV operator must add equipment to expand the capabilities of the VOD server.

Generally, once a CATV operator selects a VOD system vendor, expansion of the system to accommodate a larger video inventory or a larger base of the VOD customers, requires that the CATV operator purchase compatible equipment from the same VOD systems vendor. Accordingly, the CATV operator is unable to take advantage of advances in VOD technology, such as advanced VOD memory storage or advanced VOD systems in general, unless the initially selected VOD systems vendor offers such advanced and/or reduced cost technology.

Furthermore, since the equipment offered by competing VOD systems vendors is not interoperable with exiting legacy systems, the VOD system of a given CATV operator must be all from the same VOD systems vendor. If the CATV operator elects to upgrade to more advanced (and possibly less expensive) VOD equipment, it often means that the CATV operator's legacy VOD equipment must be scrapped.

### SUMMARY OF THE INVENTION

The present invention is embodied a system method and apparatus for use as a video on demand (VOD) gateway that allows multiple incompatible and non-interoperable VOD systems to function as a single unified VOD system. By use of the VOD gateway of the present invention, a CATV operator who has existing legacy VOD system equipment procured from a single VOD system vendor, may expand the existing legacy VOD system capacity by adding equipment from other VOD system vendors. In such manner, the CATV operator is able to take advantage of advanced technology and reduced costs offered by competing VOD system vendors without rendering existing legacy VOD system obsolete.

The present invention is further embodied in a VOD gateway system including a VOD asset gateway, a VOD session gateway and a VOD transaction gateway. The VOD gateway is located at the CATV headend or other transmitting station of a broadcast communications system. Furthermore, the present invention is embodied in generic VOD client software residing in a CATV set-top box or other receiving station of a broadcast communications system.

The VOD asset gateway aggregates video inventory from multiple VOD vendor's equipment and presents a single unified listing of VOD titles to the viewer. The VOD asset gateway reformats or translates the proprietary protocols used by multiple VOD vendor's equipment to a generic protocol describing all VOD assets. The VOD session gateway at the headend translates or reformats a subscriber request in a generic protocol for a VOD program to the specific protocol for a proprietary VOD system. Finally, the VOD transaction gateway distributes transactions reported by the set-top box so that VOD transactions are reported to the proper business management and/or billing for each type of VOD vendor's equipment. The VOD transaction gateway translates or reformats the transaction reporting protocol from the generic VOD client software residing in the CATV set-top box to the specific protocol used by the particular VOD vendor's business management system.

In an alternate embodiment, the VOD gateway of the present invention permits operators of multiple CATV systems to use multiple incompatible and non-interoperable VOD systems in each of a plurality of separate CATV systems.

That is, by the use of the VOD gateway of the present invention a CATV multiple systems operator (MSO) can purchase VOD equipment from a plurality of manufacturers and place such VOD equipment in any one of a plurality of CATV systems. In such case, even though each CATV system uses only one type of VOD equipment, the VOD gateway of the present invention permits the MSO to place (and replace) VOD equipment from any manufacturer in any CATV system.

### BRIEF DESCRIPTION OF THE DRAWINGS

FIG. 1 is a block diagram of a VOD system in accordance with the prior art.

FIG. 2A is a block diagram of a VOD gateway system in accordance with the present invention.

FIG. 2B is a block diagram of an alternate embodiment of a VOD gateway system in accordance with the present invention.

FIG. 3 is a block diagram illustrating further details of a VOD gateway system in accordance with the present invention.

FIG. 4 is a block diagram illustrating a VOD asset gateway in accordance with the present invention.

FIG. 5A illustrates an embodiment of a VOD session gateway operated in server mode in accordance with the present invention.

FIG. 5 illustrates an alternate embodiment of a VOD session gateway operated in client mode in accordance with the present invention.

FIG. 6 is a signal flow diagram illustrating the signal flow through a VOD session gateway in accordance with the present invention.

FIG. 7 is a timing diagram illustrating the various time windows for delivering a VOD program.

### DETAILED DESCRIPTION

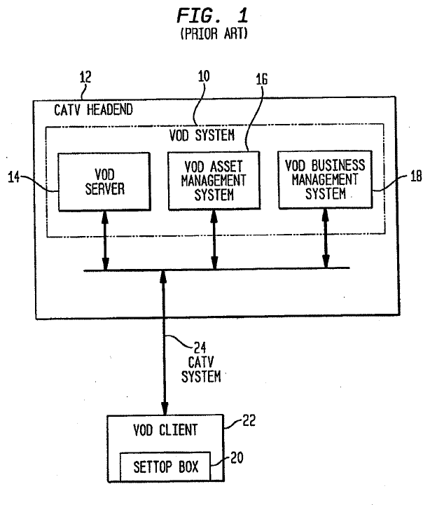

As shown in FIG. 1, a prior art VOD system 10 located in the headend 12 of the CATV system includes a VOD server 14, a VOD asset management system 16 and a VOD business management system 18. A CATV set-top box 20 is located in the home of the TV viewer and includes a VOD client software program 22 running in the set-top box 20.

Generally, the VOD client software 22 communicates with the VOD asset management system to display lists of available video programming to the CATV subscriber. The subscriber selects a video for viewing, and the VOD server 14 delivers the selected video to the set-top box 20. The resulting transaction (purchase of the video) is processed by the VOD business management system 18 whereby the viewer pays or is billed for the purchased video.

As indicated above, in order to expand the VOD system 10, additional VOD servers 14 need to be added. However, since the VOD client software 22 will only work with VOD server 14, only VOD servers that are compatible with the existing VOD server 14 may be used. In order to take advantage of advanced technology or less expensive VOD systems, the VOD client software 22 and the VOD system 10 must be changed. Changing to a new VOD system results not only in the obsolescence of the existing VOD system 10, but also locks the CATV operator into yet another technology.

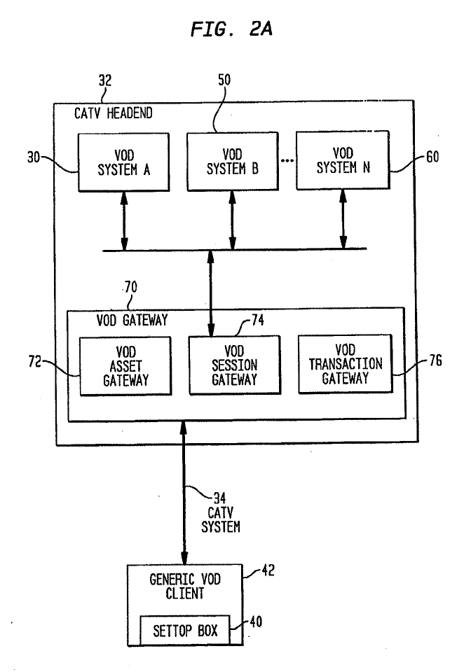

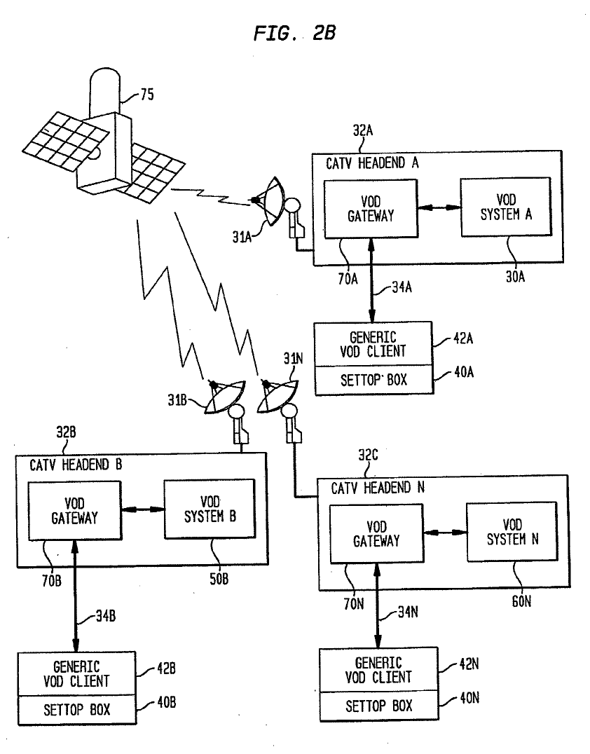

A VOD gateway 70 in accordance with the present invention is shown in the block diagram of FIG. 2A. A CATV headend 32 includes VOD systems from multiple vendors such as VOD system 30 from vendor A, VOD system 50 from vendor B and VOD system 60 from vendor N. All of the distinct, proprietary and incompatible VOD systems 30, 50, 60 communicate to the same set-top box 40 through a generic VOD client software 42 via a common VOD gateway 70. The VOD gateway 70 includes a VOD asset gateway 72, a VOD session gateway 74 and a VOD transaction gateway 76.

In operation, the VOD asset gateway 72 communicates with each VOD system 30, 50, 60 in order to aggregate all of the separate VOD videos from all vendors into a single listing of VOD assets. The unified lists of VOD assets is presented at the set-top box 40 via CATV system 34 and the generic VOD client 42.

The subscriber at the CATV set-top 40 selects a given video for viewing. The VOD session gateway 74 receives the request for the given video from the subscriber and communicates with the appropriate VOD system 30, 50, 60 that serves the particular given video selected by the subscriber. The VOD pump within the selected VOD system 30, 50, 60 delivers the purchased video to the set-top box 40 over the CATV system 34.

The transaction (purchase of the given video) is processed by the VOD transaction gateway 76. The transaction is communicated to the appropriate VOD system 30, 50, 60 that provided the particular given VOD selection to the subscriber.

In such manner, incompatible and non-interoperable VOD systems 30, 50, 60 form a single VOD system. The respective VOD video inventories are made available to the set-top box 40 as a single VOD service. Thus, VOD systems from different vendors, using different technology may be mixed and matched without changing the generic VOD client software 42.

An alternate embodiment of a system employing the VOD gateway of the present invention is shown in the block diagram of FIG. 2B. A CATV multiple systems operator distributes satellite 75 signals to multiple CATV headends 32A, 32B, 32N. Each CATV headend 32A, 32B, 32N includes a VOD system from one of multiple VOD vendors such as VOD system A 30A from vendor A, VOD system B SOB from vendor B and VOD system 60N from vendor N. All of the distinct, proprietary and incompatible VOD systems 30A, SOB, 60N communicate with each respective set-top box 40A, 40B, 40N through the same generic VOD client software 42A, 42B, 42N via a respective VOD gateway 70A, 70B, 70N. The VOD gateways 70A, 70B, 70N in FIG. 2B are substantially identical to each other and each include a respective VOD asset gateway, a VOD session gateway and a VOD transaction gateway, similar to that shown in FIG. 2A.

In such manner, the CATV multiple system operator may purchase and use incompatible and non-interoperable VOD systems 30A, SOB, 60N. Each of the incompatible VOD systems 30A, SOB, 60N may be placed in operation in any of the CATV headends 32A, 32B, 32N without changing the VOD client 42A, 42B, 42N. In each case, the respective VOD gateway 70A, 70B, 70N assures compatibility with a respective substantially identical generic VOD client 42A, 42B, 42N. Thus, VOD systems from different vendors, using different technology may be mixed and matched in any of the MSOs CATV systems 32A, 32B, 32N without changing the generic VOD client software 42A, 42B, 42N or the VOD gateway 70A, 70B, 70N.

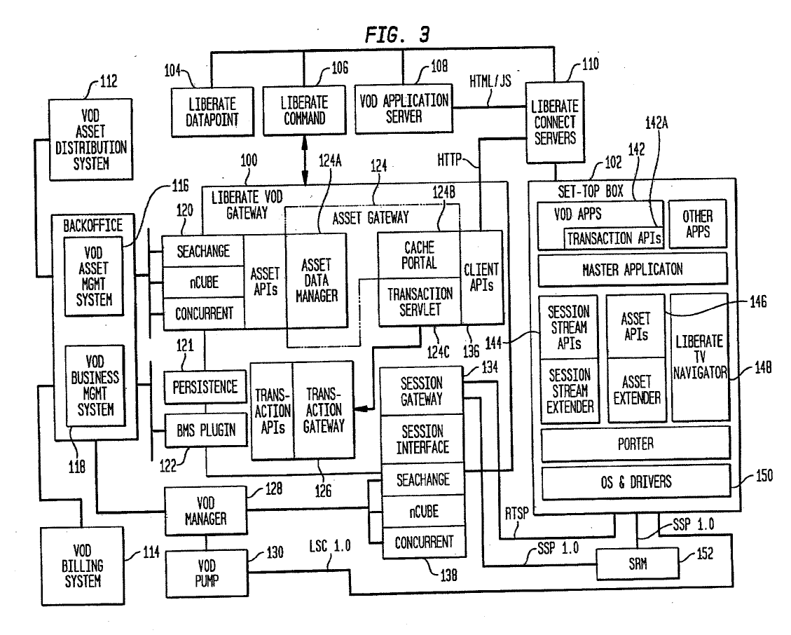

A VOD gateway for use in the CATV system in accordance with the present invention is shown in further detail in FIG. 3. There are two VOD gateway configurations: digital storage media command and control (DSM-CC) configuration and real time streaming protocol (RTSP) configuration. Digital storage media command and control (DSM-CC) signaling is widely used in a majority of VOD service trial and deployments today. In the real time streaming protocol (RTSP) based VOD Gateway Integration, the VOD Gateway is integrated with multiple VOD server vendors through the same asset and transaction integration as in the case of digital storage media command and control (DSM-CC). The only difference is that real time streaming protocol (RTSP) protocol is supported via the session gateway for session signaling and stream control.

The VOD gateway 100 includes an asset gateway 124, a transaction gateway 126 and a session gateway 134. The VOD gateway 100 is coupled to a Liberate Command server 106 and Liberate Datapoint server 104. The Liberate Command server (provided by Liberate Technologies) 106 provides configuration management for all headend servers. The Liberate Datapoint server 104 stores the data characterizing the subscriber's account and capabilities of the set-top box 102. The set-top box 102 generally has limited persistent storage for holding characterizing data. The Liberate Datapoint server 104 holds data needed by the set-top box 102, including client VOD configuration data.

The asset gateway 124 is composed of an asset data manager 124A and a cache portal 124B. The asset data manager 124A is coupled to a VOD asset management system 116 and a VOD asset distribution system 112 via asset APIs and custom interface programs 120. A specialized custom designed interface program 120 is provided for each type of VOD vendor equipment. That is, one customized program is written for each VOD equipment manufacturer, such as SeaChange, nCube, Concurrent etc.

The transaction gateway 126 is coupled to a VOD business management system 118 and a VOD billing system 114 via transaction APIs and custom plugins 122. Depending upon the VOD business management system used by the service provider, a specialized custom designed BMS (Business Management System) plugin 122 is written for each business management systems provider. In some cases, the VOD equipment supplier provides a business management system. In other cases, the VOD equipment supplier relies on a third party to provide a business management system 118 and billing system 114. In either case a BMS plugin 122 is required so that the transaction gateway 126 can report VOD transactions. For this purpose, a transaction servlet 124C report VOD transactions via a suitable client API 136.

The transaction gateway 126 is intended to be a stateless entity. However, the transaction gateway 126 may need to access client transaction related data. In order to provide a memory of each subscriber client's transaction status, an external database memory 121 (persistence) is provided to store client states and client transaction related data.

The session gateway 134 is coupled to a VOD server comprising VOD manager 128 and VOD pump 130 via session APIs and custom interface programs 138. As in the case for the asset gateway 124 and the transaction gateway 126, specialized custom designed interface programs 138 are provided for each type of VOD vendor equipment. The session gateway 134 communicates with the set-top box 102 using the Session Resource Management (SRM) 152 and the Session Set up Protocol (SSP 1.0). Session APIs interface with external VOD servers for session signaling protocol conversion with the settop client, including session setup and tear down. The Session Resource Management performs such functions as determining the bandwidth required for given session and allocating the necessary frequency spectrum as required for the session. The Session Resource Management communicates the assigned VOD channel to the VOD client in the set-top box. In such manner, the set-top box tuner is able to tune to the channel containing the video that was ordered by the subscriber.

The VOD manager 128 is also coupled to the asset management system 116 and the VOD business management system 118. The subscriber selects a video by the use of the asset management system 116. The subscriber pays for the video by the use of the VOD business management system 118. In response to selection of a video by the subscriber and payment authorization by the VOD billing system 114, the VOD manager 128 enables VOD pump 130, which delivers the requested video. The requested video is transmitted as a digital data stream controlled by either the Lightweight Stream Control Protocol (LSC 1.0) or Real-time Streaming Protocol (RTSP).

The set-top box 102 includes a master application 140 (executive program) on top of which various applications such as VOD application 142 is run. The VOD application program 142 calls upon session stream APIs 144 (client session stream extender interface) and asset APIs 146 (client asset extender interface). A Liberate TV Navigator program 148 (provided from Liberate Technologies) controls the general look and feel of the set-top box 102, i.e. the manner in which the subscriber controls the programs and features of the set-top box 102. Below the master application 140 is the Liberate Porter and operating system and drivers 150 which match the software to the set-top box hardware.

In addition, the VOD application 142 retrieves data and graphics for the VOD presentation on the set-top box. In particular, VOD application 142 uses the program related data (such as an Internet URL) to communicate via connect servers 110 to a VOD application server 108. Graphics and presentation images needed by the VOD application 142 are received from VOD application server 108. The VOD application 142 also calls upon transaction APIs 142A to report VOD transactions through the asset gateway transaction servlet 124C.

At the client (settop box) side, a generic software client is provided as the extenders for a standard Liberate TV Navigator platform 148. The generic client includes the following modules and interface APIs to the VOD application developer:

Session extender and APIs 144 provide either digital storage media command and control (DSM-CC) user network signaling based on the session setup protocol (SSP) or real time streaming protocol (RTSP) protocol for VOD session signaling.

Stream extender and APIs 144 provide the VOD trick modes (play, pause, fast forward, rewind, etc.) enabled via the Stream Control Protocol. Two versions are supported: digital storage media command and control (DSM-CC) based Lightweight Stream Control Protocol (LSCP) or real time streaming protocol (RTSP).

Asset extender and APIs 146 provide JavaScript and Java based interfaces for asset metadata query for the client VOD application. In addition to the raw content of an asset, metadata is also a part of an asset object that describes characteristics of the asset. Metadata includes inherent attributes of the asset such as format, duration size or encoding method. The asset list can be cached at the settop box, retrieved from data carousel, or fetched via HTTP two-way interface through DOCSIS or out-of-band channels.

Using the VOD Gateway approach of the present invention, only a single client (supporting either digital storage media command and control (DSM-CC) or real time streaming protocol (RTSP)) needs to be provided and maintained no matter which VOD server will be used. In addition, the VOD client allows the integration with third party VOD application through Internet standard interfaces such as HTML (hypertext markup language) and JavaScript and Java.

The VOD Gateway architecture of FIG. 3 uses either digital storage media command and control (DSM-CC) or real time streaming protocol (RTSP) configuration. The key modules are defined as:

Asset data manager 124A manages the asset metadata with external sources and distributes the metadata to the cache portal 124B.

Cache Portal 132 manages the client query of asset list and downloads the asset metadata to the client through a data carousel or HTTP.

Session Gateway 134 provides the protocol conversion from generic session protocol to VOD vendor specific protocols. Another purpose of session gateway can be to provide authentication interfaces for session set-up or tear down.

Transaction Gateway 126 provides transaction interaction such as a movie purchase with backoffice VOD billing system 114.

### Asset Gateway Architecture

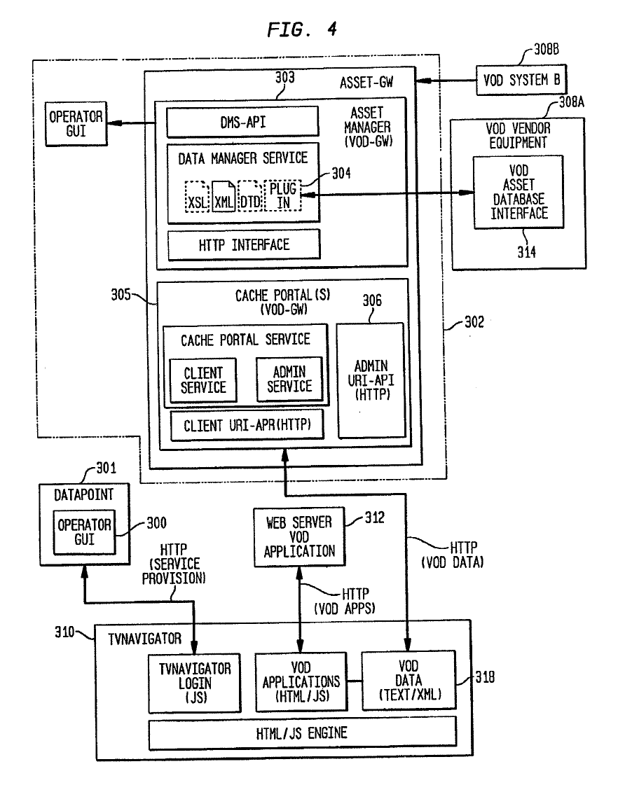

FIG. 4 is a block diagram illustrating further details of a VOD asset gateway 302. The VOD asset gateway 302 includes an asset manager 303 (124A in FIG. 3) and a cache portal 305 (124B in FIG. 3). The asset manager 303 includes an asset plugin 304 for retrieving lists of assets from the VOD asset database interface 314 in VOD vendor equipment 308A. The asset plugin 304 retrieves the VOD asset data from the VOD asset database 314 and remaps the VOD data according to a unified generic schema.

The reformatted VOD asset data is cached in a cache portal 305 and made available as VOD data to the set-top box 310. The set-top box 310 further communicates with a Liberate Datapoint server 301 wherein it is provided with data and parameters to enable a VOD service. Additionally, the set-top box 310 includes VOD applications which retrieves graphics and presentations from a VOD application Web server 312.

The following sections describe a generic Movie On Demand asset metadata format that is used to describe Movie On Demand assets for the VOD Gateway.

Movie On Demand Asset Metadata is used to describe the properties of movie content contained in the asset, such as the movie title, preview, and poster etc. Metadata consists of keyword-value pairs and is described in XML (extensible markup language) format. The format allows for easy extensions with respect to new metadata entries. A DTD file is used to describe the syntax of XML asset metadata file.

The VOD asset gateway is ignorant of the assets that it hosts. As used herein, VOD program material (assets) may be video, audio, graphic or text programming. All assets are treated as a Product, Service, or Offering Entity. Product entities may be movies, news clips, games, and/or any other MIME type supported by the Liberate TV Navigator Client. Service entities are logical groupings of runtime behaviors and rules such as Basic Movies-On-Demand Service, Premium Movies-On-Demand Service, Music Videos-On-Demand Service, and so on. Offering entities relate Product entities to Service entities, similarly to the way foreign keys work in a relational databases. A Product must be “offered” to one or more Services via Offerings, in order to be utilized by a Liberate TV Navigator VOD application.

For example, a Product of type Movie Title may have two Offerings. One Offering is for a Service called “Basic Movies-On-Demand” and another Offering is for “Premium Movies-On-Demand”. The “Basic Movie-On-Demand” Service may have rules that do not allow stream control (trick-mode) support when viewing the movie. The “Premium Movies-On-Demand” Service may enable these controls.

### Product

Products may have Parameters and Metadata. A Parameter is a data name/value pair that is predefined, and represents some relevant descriptive attribute about the Product. Parameters may be validated by the asset data manager. Metadata is also a name/value pair, but is NOT validated by the asset data manager. Metadata may be passed down to the Liberate TV Navigator client with no checks.

For example: A Move Title Product:

This Product may have the following Parameters:
title—The title of the Movie Title.
rating—Movie Title rating.
short_summary—A short summary of the Movie.
year—The year of the Movie release.
actors—A list of actors/actresses.
genre—A list of genres associated with the Movie.
director—The Director's name.
studio—The Studio name.
run_time—the length of the Movie (HH:MM:SS)
poster_id—the Url of the Poster image
movie_id—The unique id used to identify the video on the stream server.
rental_period—The length of time allowed for viewing the video stream.

These parameters may be required for a Movie-On-Demand Application.

The Product may also have Metadata associated with it. The data may not be part of the Movie Title, but added in to compliment an application. For example:
more_info url—a Url that references an Internet source to give more details about the Movie Tile.
special_offer_advertisment_url—a Url that references special advertisements relevant to the Movie Tile.
chat_group_url—a Url that references a chat group dedicated to movie reviews.

### Service

The VOD Service Provider may define Service entities. Services allow providers to set business rule parameters, which are used by the VOD application. Products offered to a particular Service is then governed by those rules set in that Service. Similarly to Product entities, Service entities also have Parameters and Metadata.

For example: A Movie-On-Demand Service may have the following Parameters:
title—the title of the Service (i.e. Basic or Premium Movies-On-Demand).
stream_control_enabled—this parameter may be a true/false flag telling the client application to enable or disable the “VCR-controls” at run-time.
advertisment_window_enabled—this parameter may be used to trigger intrusive advertisements during the session setup period.

Again, like Product entities, a Service may also have associated Metadata.
on_pause_url—a Url that is fetched on a stream pause event.

### Offering

Offering entities are similar to both Products and Services in that they have Parameters and Metadata, however, Offerings have two additional attributes: a “pref” (Product Reference) and an “sref” (Service Reference). The Product Reference attribute is the foreign key of its related Product entity. The Service Reference attribute is the foreign key of its related Service entity. An offering must have a one pref and one sref attribute.

Offering Parameters should relate to the context of that particular offering. For example an Offering of a Movie Title Product may have the following Parameters.
offer_period_start_date—offering becomes valid to subscribers on this date.
offer_period end_date—offering expires on this date.
discount—the discount rate to be applied to the Product's “rental_price” Parameter.

Metadata usage is the same as Product and Service.

The VOD asset gateway uses Product, Service, and Offering entities to describe asset data and to set runtime values for VOD applications. Each entity supports Parameters and Metadata. Data is considered a Parameter, if it is required for the application to function.

### Session Gateway Architecture

The Session Gateway is a server component of the VOD gateway. It is designed to allow full configuration based on standard protocols such as digital storage media command and control (DSM-CC) and real time streaming protocol (RTSP). The Session Gateway is introduced to provide two main functions:

(1) It provides protocol translation between the generic session protocol and the VOD vendor specific session protocols. A single generic client extender for session signaling is thus used for multiple VOD vendors.
(2) It facilitates a unified approach for authorization, statistics collection, and monitoring of VOD sessions. The latter is accomplished through the interface between the session gateway and transaction gateway, that is further integrated with external VOD backoffice system.

The VOD gateway is designed to have two fully configurable modes of operations for Session Gateway: digital storage media command and control (DSM-CC) and real time streaming protocol (RTSP). It is not likely that the digital storage media command and control (DSM-CC) and real time streaming protocol (RTSP) are supported by a particular cable system VOD deployment at the same time. Therefore, VOD gateway is designed to be configurable to either digital storage media command and control (DSM-CC) or real time streaming protocol (RTSP) at the system installation stage.

Only the digital storage media command and control (DSM-CC) session signaling messages are handled through the Session Gateway while the stream control messages are always sent directly between the client and VOD server. It is usually the case that the DSM-CC stream control messages are the same across all the VOD vendors therefore it is handled directly for better scalability.

The Session Gateway can be scaled and deployed as an independent component of VOD gateway in the master or remote headends.

### Digital Storage Media Command and Control (DSM-CC) Session Gateway Architecture

There are three logical entities in the digital storage media command and control (DSM-CC) model, Client, Server, and Network. The Network entity is always the session resource manager (SRM) that will be provided by headend provider or VOD vendor. It is responsible for assigning the network resources such as MPEG channels for VOD sessions. The Client entity is provided by generic client extender and is responsible for initiating the session setup request/release and the Server entity is provided by VOD vendors and is responsible for negotiating with session resource manager (SRM) for network resources and assigning the streaming server for the client.

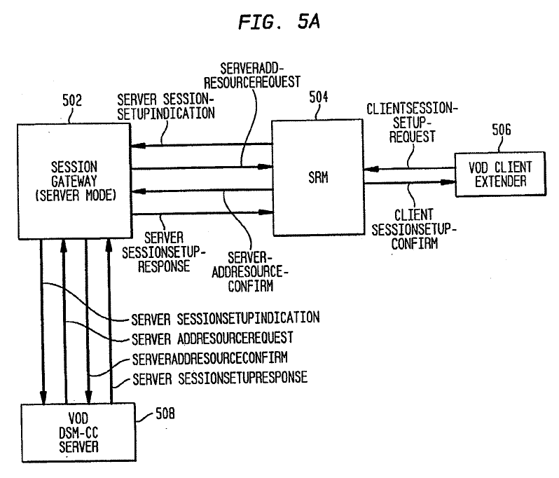

There are two modes of operation for the digital storage media command and control (DSM-CC) Session Gateway: Server Mode and Client Mode. In the Server Mode (illustrated in FIG. 5A), the Session Gateway sits between the session resource manager (SRM) and VOD Server. In the Client Mode (illustrated in FIG. 5B), the Session Gateway sits between the Client and session resource manager (SRM). The mode is fully configurable upon the installation of the Session Gateway. The decision of which mode to use is based on the combination of headend and VOD vendors used as part of the integration and deployment planning.

Server Mode digital Storage Media Command and Control (DSM-CC) Session Gateway

FIG. 5A illustrates the Server Mode digital storage media command and control (DSM-CC) session gateway architecture with the Session Setup scenario. In Server Mode, the session gateway 502 serves as the translation engine for the server side digital storage media command and control (DSM-CC) messages between the session resource manager (SRM) 504 and VOD server 508. The VOD client extender 506 communicates with the Session Resource Management 504.

The communication between client and session resource manager (SRM) uses the UDP protocols while the communication between session resource manager (SRM) and Session Gateway as well as between Session Gateway and VOD server uses TCP protocol.

The message flow of session setup scenario for Server Mode digital storage media command and control (DSM-CC) Session Gateway is described in the following:

Step 1: Start session setup
Step 2: Generic client extender sends ClientSessionSetupRequest message to session resource manager (SRM) with Client ID (OSI network service access point address including IP address and Media Access Control address), NodeGroup ID private descriptor, and Asset ID private descriptor. Session ID is determined by the client.
Step 3: session resource manager (SRM) sends ServerSessionSetupIndication message to Session Gateway.
Step 4: Session Gateway translates the user private data field of the generic digital storage media command and control (DSM-CC) message to the VOD vendor specific format and forwards the modified ServerSessionSetupIndication message to VOD server.
Step 5: VOD server requests the network resource with required Resource Descriptor in the ServerAddResourceRequest message to Session Gateway.
Step 6: Session Gateway forwards ServerAddResourceRequest to session resource manager (SRM) (with reformatting if necessary)
Step 7: session resource manager (SRM) assigns the network resource to the session and sends ServerAddResourceConfirm message to Session Gateway
Step 8: Session Gateway forwards the ServerAddResourceConfirm message to VOD server (with reformatting if necessary).
Step 9: VOD Server sends ServerSessionSetupResponse to Session Gateway
Step 10: Session Gateway forwards the ServerSessionSetupResponse to session resource manager (SRM) (with reformatting if necessary)
Step 11: session resource manager (SRM) inserts client view of resource descriptor and sends ClientSessionSetupConfirm message to the generic client extender.
Step 12: Client retrieves resource descriptor with tuning information such as Frequency and ServiceID as well as stream control IP address. And the session is established.

### Client Mode Digital Storage Media Command and Control (DSM-CC) Session Gateway

FIG. 5B illustrates the Client Mode digital storage media command and control (DSM-CC) session gateway architecture with the Session Setup scenario. In FIG. 5A, the session gateway 502 communicates with the Session Resource Management 504, which in turn communicates with the VOD client extender 506 in the set-top box. In comparison, the session gateway 522 in FIG. 5B is operated in a client mode. That is, the VOD client extender 524 in the set-top box communicates with the session gateway 522, which in turn communicates with the Session Resource Management 520, which provides the interface to the VOD digital storage media command and control (DSM-CC) server 526.

In client mode shown in FIG. 5, the session gateway 522 serves as the translation engine for the client side digital storage media command and control (DSM-CC) messages between the client 524 and session resource manager (SRM) 520.

In the client mode case, the communication between client and Session Gateway as well as between Session Gateway and session resource manager (SRM) uses the UDP protocols while the communication between session resource manager (SRM) 520 and VOD server 526 uses TCP protocol.

The message flow of session setup scenario for Client Mode digital storage media command and control (DSM-CC) Session Gateway is described in the following:

Step 1: Start session setup
Step 2: Generic client extender sends ClientSessionSetupRequest message to Session Gateway with Client ID (OSI network service access point address including IP address and Media Access Control address), NodeGroup ID private descriptor, and Asset ID private descriptor. Session ID is determined by the client.
Step 3: Session Gateway translates the user private data field of the generic digital storage media command and control (DSM-CC) message to the VOD vendor specific format and forwards the modified ClientSessionSetupRequest message to session resource manager (SRM).
Step 4: session resource manager (SRM) sends ServerSessionSetupIndication message to VOD server.
Step 5: VOD server requests the network resource with required Resource Descriptor in the ServerAddResourceRequest message to session resource manager (SRM).
Step 6: session resource manager (SRM) assigns the network resource to the session and sends ServerAddResourceConfirm message to VOD server
Step 7: VOD Server sends ServerSessionSetupResponse to session resource manager (SRM).
Step 8: session resource manager (SRM) inserts client view of resource descriptor and sends ClientSessionSetupConfirm message to Session Gateway.
Step 9: Session Gateway translates the VOD vendor specific user private descriptors and resource descriptor if necessary and forwards the ClientSessionSetupConfirm message to the generic client extender.
Step 10: Client retrieves resource descriptor with tuning information such as Frequency and ServiceID as well as stream control IP address. And the session is established.

### Real Time Streaming Protocol (RTSP) Session Gateway Architecture

Real time streaming protocol (RTSP) supported by VOD gateway is based on the Internet Engineering Task Force RFC 2326 standard with the hybrid fiber coax (HFC) extensions proposed by nCUBE. Several VOD vendors have adopted real time streaming protocol (RTSP) for trial and deployment of VOD services. Real time streaming protocol (RTSP) protocol has its unique capabilities when used for VOD systems:

Real time streaming protocol (RTSP) protocol supports multiple Asset streaming per session instead of digital storage media command and control (DSM-CC) (session setup protocol (SSP)) that only allows one Asset per Session

Real time streaming protocol (RTSP) has HTTP like syntax that is easy for developer to implement.

The hybrid fiber coax (HFC) extension of real time streaming protocol (RTSP) supports MPEG resource parameter.

The basic architecture for real time streaming protocol (RTSP) Session Gateway is to use the Session Gateway to handle both session and stream related real time streaming protocol (RTSP) messages and to perform protocol translation between generic real time streaming protocol (RTSP) message initiated from the client and VOD vendor specific messages. In such manner, a generic real time streaming protocol (RTSP) extender is maintained for all the VOD vendors. The operation is similar to the operation of HTTP Proxy server. Also, the VOD server does not require IP level message authentication.

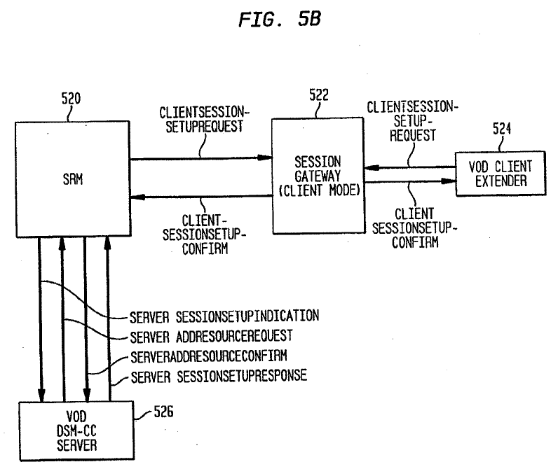

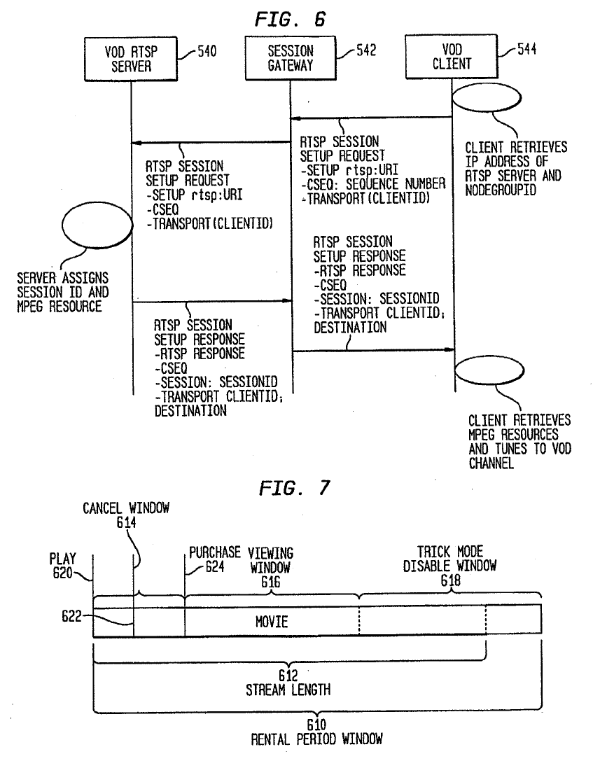

The detailed real time streaming protocol (RTSP) message flows are illustrated in FIG. 6.

### Transaction Gateway Architecture

The purpose of the Transaction Gateway is to authorize the delivery of media services to a set-top user. It also abstracts the external components (such as Billing) away from set-top client implementation.

The concept of a “Transaction” is used to represent a rental-period or time period, which a set-top user would have to view a given media asset. The Transaction gateway offers the following:
1. Authorization Interface: provide an authorization pathway allowing authorization requests to be routed to an external authorization processor. This is integrated with the information from the Asset Manager.
2. Purchase history: provide purchase history of completed Transactions.
3. Active or Suspended Sessions: a means for both the set-top client software and external server components of the back office to interact with Transactions that are currently in progress or currently stalled or stopped Transactions. This information can be used for billing implementations, advertisement insertion, tracking and usage collection.

### Authorization

No attempt is made within the VOD gateway to define the business rules for authorizing services and billing to customers. The logical decision to authorize a particular request is made by an external authorization implementation listening to an interface on the VOD gateway. The VOD gateway provides a way to host many such authorization requests concurrently, integrating the request information with that of the Asset Manager and routing the request to the appropriate authorization implementation. Once a Transaction is authorized, the Transaction can be stopped and restarted without the interaction of the external authorization component.

### Active Transactions

Once a Transaction becomes authorized from the appropriate external authorization implementation, it becomes an “active” Transaction. Active Transactions contain all the default information about the Transaction and any custom information inserted by the set-top client software or an external server-side component. The default information within the Transaction indicate what set-top, service, application, offering is being delivered. The Transaction remains “active” for the duration of the rental-period.

### Purchase History

Once a Transaction has gone beyond it's rental-period, it transitions to being a “completed” Transaction. In this state, the set-top client can request information about all or individual previous sessions.

### Billing

When an external billing implementation registers with the VOD gateway for the first time, the registration is remembered by the VOD gateway. Based on the registration criteria, all messages defined in the registration are held within the VOD gateway for delivery to this implementation. Once these messages are delivered, they can be dropped by the VOD gateway going forward. In this way, the billing implementation can still operate in a batch mode.

The Transaction interface operates in a similar fashion to Billing but does not offer any durability or holding of messages from the past.

### Transaction Lifecycle

The following sequence diagram captures a possible scenario for the setup and teardown of a video session with the Session Gateway from a set top client. Some detail has been left out for simplicity. This attempts to show how the transaction flows through to the VOD gateway.

### Session Setup Request/Authorization

Before the Session Gateway sets up the session on the VOD server, it first gets authorization from the Transaction Gateway component.

Upon receiving an Authorization request, the Transaction Manager performs the following processing:
1. Checks the required parameters are present for starting/re-starting a Transaction. These are: machine, application and offering identifiers. If the required parameters are missing from the request an immediate denial is sent to the requester.
2. Fetches other details like product and service by using the Delivery CachePortal.
3. Attempts to find a stalled Transaction.
4. If no stalled session exists, the augmented request is sent to the correct Authorization interface and its reply is forwarded to the requestor.
5. If a stalled Transaction exists, then this is forwarded to the requestor.

Both the original augmented request and any Authorization interface reply are published to the Transaction topic.

Upon the authorization of VOD session, the Session Gateway can then set up the session with the specific vendor VOD server. The Session Gateway could then send a message indicating that the session has started.

The client upon successfully initiating streaming can send updates about the “session” to the DeliveryServlet. The DeliveryServlet posts this information to the Transaction Gateway where this information is published to the Transaction topic.

### Billing Rules/Purchase

The external Billing implementation subscribes to the Billing interface. Whether the Billing system chooses to initiate billing and add a line item on a customer's monthly bill is entirely up to each system. The flexibility is achieved by passing a filter/query string to the register method on the interface (more detail below). This will restrict the reception of messages to those specifically defined in the query. For a given deployment this can be a sessionState=Started event or an event driven by the client UI application in the set-top, i.e. deliveryState=ViewingWindow.

The billing rules can be partially supported on the client via the HTML and JavaScript and Java environment during the duration of the video session. The client can change the values of the “deliverystate” within the Transaction to reflect the current condition and state, e.g.: CancelWindow or ViewingWindow.

FIG. 7 illustrates the control over the viewing window for a VOD program. The stream length 612 is equal to the duration of the VOD program ordered. The total rental window 610 however, is longer than the total stream length 612 of the VOD program. After the VOD program begins to play 620 there is a cancel window 614 during which the consumer may decide to cancel 622 the VOD program. After the cancel window 614 has passed, the VOD video is regarded as having been purchased 624 and the viewer is billed for the purchase. Initially, trick mode (pause, rewind, etc.) is available to the viewer. However, after the viewing window 616, the trick mode disable window 618 disables trick mode to guarantee that the stream length 612 will fit within the rental window 610. In such manner, the movie can run completely with in the rental window 610.

The movie stream ends, or the user stops the movie but the session is torn down eventually. If the connection to the client is lost, the Session gateway may tear down the disconnected session. In any event, the Session gateway notifies the Transaction gateway, thus completing the Session gateway's role and responsibilities with respect to the Transaction gateway.

### Transaction Gateway Interface Definitions

The interfaces used by Transaction Gateway are Authorization, Billing, Transaction, PersistedTransaction, and DeliveryRequestor.

The Authorization and Billing interfaces are used by external systems to perform these specific tasks.

The progress and control of current transactions can be achieved by connecting to the Transaction interface. History of all previous purchase activity can be collected from the Transaction interface. History information can then be made available to the VOD gateway from an external system hosting the PersistedTransaction interface.

The Delivery section details the main functionality of this component, namely to track the activity of all active media transactions. The Delivery interface as detailed here is used by other VOD gateway components to drive information through the Transaction gateway.

All the interfaces for the Transaction Gateway use a common message format. This message format or DeliveryMessage has some predefined parameters and states.

### Transaction Usage Interface

The Transaction represents the delivery of a Product (asset) to a user and thus can have many video sessions started and stopped during its lifetime. This time-to-live window is set from the imported product or the default in Command.

The Transaction definition below is what the client can use in request-queries for currently running Transactions. Once a Transaction is started via the extender and the Session Gateway, this information is available for the session.

The client can push any name-value pair into the DeliveryMessage and have this be available for later use. An external component can also push name-value pairs into the Transaction.

A typical query to the DeliveryRequestor interface with the request method would include the mid, appid, sid. This would retrieve all the current Transaction or stalled sessions.

Any pre-defined parameter can be used for building “selectors” or when filtering messages coming through the interfaces. These are defined below and as constant String(s) in the DeliveryConstants class. The various states have their own definition interface classes.

### Authorization Interface

The Authorization interface is hosted within the VOD gateway. External implementations for authorization processing are clients to this interface.

### Billing Interface

The billing interface is hosted within the VOD gateway. External implementations of billing are clients to this interface. It allows an external billing system to receive and send billing related messages from/to the VOD gateway.

### Transaction Interface

The Transaction interface is hosted within the VOD gateway. External components are clients to this interface. This interface allows external systems to receive and send specific messages from and to the VOD gateway.

### PersistedTransaction Interface

This interface is hosted outside the VOD gateway. The VOD gateway is a client to this interface and the class or implementation is loaded at run time. This interface allows an external system to host and store specific messages for the VOD gateway. The implementation for this interface is not part of the VOD gateway. The Transaction Gateway expects that PersistedTransaction interfaces named “ActiveSessions” and “PreviousSessions” will exist. It attempts to connect to these before initiating service. Failures to these connections are ignored with the information lacking from within the Transaction Gateway.

### DeliveryRequestor Interface

This interface feeds and listens to the external interfaces described above but also presents a client-centric interface within the VOD gateway. The following table shows the internal services provided within the VOD gateway.

### Generic Client Extender and APIs

The Liberate TV Navigator standard architecture provides several VOD Extenders and JavaScript and Java libraries for facilitating quick development of Video On Demand Application on top of the middle-ware. In the current Liberate TV Navigator Standard architecture there are two extenders that provides a JavaScript and Java based interface for VOD Application developer and they are:
VOD Session and Stream Extender.
VOD Asset Extender.

The VOD Session and Stream Control Extender provides a generic Session class interface that allows to applications to setup and tear-down dynamic VOD sessions and also provide an interface for creating new Stream objects that can used to control VOD streasset management system through specified methods for Play, Fast Forward, Rewind, Stop. The current version of the Extender supports DSMCC based session setup protocol (SSP) (Session Setup Protocol) and real time streaming protocol (RTSP) protocols for session management and supports LSC and real time streaming protocol (RTSP) protocol for stream control/management. In near future, this interface is intended to extend support for additional user specified fields in both the session and stream management protocols.

The VOD Asset Extender interacts with the VOD gateway server to download all the VOD program asset related information and efficiently manages all such information in memory, on the set top box. The Asset Extender also provides a JavaScript and Java based interface for the VOD application to query information about various categories of prograsset management system available on the server, a short summary of the program with purchase information as well as more detailed information related to the program itself.

The Asset Extender provides three JavaScript and Java Classes: Categories, Offerings and ProgramInformation that provides good abstraction for the Application to efficiently query, manage and use VOD program related information. The schema definition for the VOD Asset database is loaded dynamically and can be changed to add any additional user/deployment specific fields. The actual VOD Asset meta-data is downloaded to the client in proposed XML format from the VOD gateway either through a two-way dedicated TCP connection or through a HTTP interface or the information can be broadcast to all the clients using the mediacast carousel. Also, the JavaScript and Java interface is intended to provide support for any additional user specified or deployment specific fields for Categories, Offerings and Program Information.

Depending on the client hardware profile the Asset Extender is designed to support very advanced searches and sorts on the server side at the VOD gateway. Such optimization are necessary depending on the limited amount of memory and processing power available on the digital set top box. In case where the VOD Asset database is much bigger than the memory available to the Asset Extender on the set top, the VOD Asset extender will only cache information based on the current application context and will swap information from the memory as this context changes. context and will swap information from the memory as this context changes.

1. In a system providing video on demand (VOD) services via any of a plurality of incompatible and non-interoperable VOD systems, a VOD gateway method comprising:
receiving a request from a receiver station for all currently available VOD assets;
transmitting to each of the plurality of incompatible VOD systems a request for a respective list of all currently available VOD assets;
receiving, in response to said request for a list of all currently available VOD assets from each VOD system, a respective list of all currently available VOD assets from each one of the plurality of incompatible and non-interoperable VOD systems, wherein each respective list is in a protocol unique to each of said plurality of incompatible and non-interoperable VOD systems;
translating at the VOD gateway each respective list received from each one of said plurality of incompatible VOD systems into a generic protocol describing all currently available VOD assets of each one of the plurality of incompatible VOD systems; and
aggregating the translated lists of all currently available VOD assets to form a combined list of available VOD assets, the combined list of available VOD assets being adapted to be compatible with a plurality of receiver stations.

2. A method in accordance with claim 1, further comprising:
in response to a request from a receiver station for a VOD asset, performing the steps of:
identifying which VOD system is associated with the requested VOD asset; and
transmitting, to the identified VOD system, a compatible request for the VOD asset.
receiving the requested VOD asset from the identified VOD system;
adapting the received VOD asset to be compatible with the requesting-receiver station; and
transacting for the requested VOD asset with the requesting receiver station and the identified VOD system.

3. A method in accordance with claim 2, wherein the requested VOD asset comprises one or more of a video program, an audio program, a graphic program and a text program.

4. A method in accordance with claim 1, wherein each of the incompatible VOD systems includes an asset management system for managing respective VOD assets and a business management system for managing transactions, said method further comprising:
communicating with each VOD asset management system using an asset gateway; and
communicating with each VOD business management system using a transaction gateway.

5. A method in accordance with claim 2, wherein a desired asset is provided to a receiver station using one or both of digital storage media command and control (DSM-CC) or real time streaming protocol (RTSP).

6. In a broadcast communications system providing video on demand (VOD) services from any of a plurality of incompatible and non-interoperable VOD systems via a VOD gateway, a method comprising:
transmitting to each of the plurality of incompatible VOD systems a request for a respective list of all currently available VOD assets;
receiving, in response to said request for a list of all currently available VOD assets from each VOD system, a respective list of all currently available VOD assets from each one of the plurality of incompatible non-interoperable VOD systems, wherein each respective list is in a protocol unique to each of said plurality of incompatible and non-interoperable VOD systems;
translating at the VOD gateway each respective list received from each one of said plurality of incompatible VOD systems into a generic protocol describing all currently available VOD assets of each one of the plurality of incompatible VOD systems;
aggregating the translated lists of all currently available VOD assets to form a combined list of available VOD assets, the combined list of available VOD assets being adapted to be compatible with a plurality of receiver stations;
receiving a request from a receiver station for a VOD asset; and
in response to a request from the receiver station for a VOD asset, performing the steps of:
identifying which VOD system is associated with the requested VOD asset via the received list of all currently available VOD assets from one of the plurality of incompatible VOD systems;
transmitting, to the identified VOD system, a compatible request for the VOD asset;
receiving the requested VOD asset from the identified VOD system;
adapting the received VOD asset to be compatible with the requesting receiver station; and
transacting for the requested VOD asset with the requesting receiver station and the identified VOD system.

7. In a broadcast communication system in accordance with claim 6, wherein each of said VOD systems includes a VOD business management system, said method further comprising:
recording an event that said given VOD program was received at said receiving station as a purchase event of said given VOD program; and
transmitting said purchase event of said given VOD program from said VOD gateway to a corresponding VOD business management system.

8. A method in accordance with claim 7, wherein the requested VOD asset comprises one or more of a video program, an audio program, a graphic program and a text program.

9. In a broadcast communications system having a transmitting station and a receiving station, said transmitting station including incompatible and non-interoperable first and second VOD systems each having a respective first and second VOD asset management system, wherein said transmitting station includes a VOD gateway and said receiving station includes a generic VOD client, a method comprising:
receiving a request from a receiver station for all currently available VOD assets;
transmitting a request from said VOD gateway to said first VOD asset management system for a first list of all currently available VOD assets stored in said first VOD system;
transmitting a request from said VOD gateway to said second VOD asset management system for a second list of all currently available VOD assets stored in said second VOD system;
receiving at said VOD gateway, in response to said requests to said first and second VOD asset management system, said first and second lists of all currently available VOD assets in stored in said first and second VOD systems, wherein said first and second lists of all currently available VOD assets are in protocols unique to each of said first and second VOD systems;
translating at said VOD gateway said first and second lists into a generic protocol;
aggregating said first and second translated lists of all currently available VOD assets to form a combined list of VOD assets;
transmitting from said receiving station to said VOD gateway a request for a list of VOD assets; and
transmitting said combined list of VOD assets from said VOD gateway to said receiving station.

10. In a broadcast communication system in accordance with claim 9, wherein said first and second VOD systems at said transmitting station further includes respective first and second VOD servers, said method of operating said VOD gateway further comprising:
selecting, at said receiving station a given VOD program from said combined list of VOD assets;
receiving, at said VOD gateway, a request from said receiving station for said given VOD program;
determining whether said request for said given VOD program specifies a VOD program originating from said first VOD server or a VOD program originating from said second VOD server;
forwarding said request for said given VOD program to said first VOD server if said given VOD program originates from said first VOD server; and
forwarding said request for said given VOD program to said second VOD server if said given VOD program originates from said second VOD server; and receiving said given VOD program at said receiving station.

11. In a broadcast communication system in accordance with claim 10, wherein said first and second VOD systems further includes respective first and second VOD business management systems, said method further comprising:
recording the event that said given VOD program was received at said receiving station as a purchase event of said given VOD program;
transmitting said purchase event of said given VOD program from said VOD gateway to said first VOD business management system if said given VOD program originates from said first VOD server; and
transmitting said purchase event of said given VOD program from said VOD gateway to said second VOD business management system if said given VOD program originates from said second VOD server.

12. A method in accordance with claim 11, wherein said given VOD program is a video program.

13. A method in accordance with claim 11, wherein said given VOD program is an audio program.

14. A method in accordance with claim 11, wherein said given VOD program is a graphic program.

15. A method in accordance with claim 11, wherein said given VOD program is a text program.

16. In a broadcast communication system having a transmitting station, a receiving station and a VOD gateway, said broadcast communication system having a transmitting station including respective first and second incompatible and non-interoperable VOD systems, said first VOD system including a first VOD server, said second VOD system including a second VOD server, and a receiving station, a method of operating said VOD gateway comprising:
receiving a request from a receiving-station for all currently available VOD assets;
transmitting a request from said VOD gateway to said first VOD server for a first list of all currently available VOD assets stored in said first VOD server;
transmitting a request from said VOD gateway to said second VOD server for a second list of all currently available VOD assets stored in said second VOD server;
receiving at said VOD gateway, in response to said requests to said first and second VOD asset server, said first and second lists of all currently available VOD assets stored in said first and second VOD servers, wherein said first and second lists of all currently available VOD assets are in protocols unique to each of said first and second VOD servers;
translating at said VOD gateway said first and second lists into a generic protocol;
aggregating said first and second translated lists of all currently available VOD assets to form a combined list of VOD assets;
receiving, at said VOD gateway, a request from said receiving station for a given VOD program;
determining whether said request for said given VOD program specifies a VOD program originating from said first VOD server or a VOD program originating from said second VOD server via said received first and second list of all currently available VOD assets from the respective first and second VOD servers;
forwarding said request for said given VOD program to said first VOD server if said given VOD program originates from said first VOD server;
forwarding said request for said given VOD program to said second VOD server if said given VOD program originates from said first VOD server; and
receiving said given VOD program at said receiving station.

17. In a broadcast communication system in accordance with claim 16, wherein said first and second VOD systems further include respective first and second VOD business management systems, said method further comprising:
recording the event that said given VOD program was received at said receiving station as a purchase event of said given VOD program;
transmitting said purchase event of said given VOD program from said VOD gateway to said first VOD business management system if said given VOD program originates from said first VOD server; and
transmitting said purchase event of said given VOD program from said VOD gateway to said second VOD business management system if said given VOD program originates from said second VOD server.

18. A method in accordance with claim 17, wherein said given VOD program is a video program.

19. A method in accordance with claim 17, wherein said given VOD program is an audio program.

20. A method in accordance with claim 17, wherein said given VOD program is a graphic program.

21. A method in accordance with claim 17, wherein said given VOD program is a text program.

22. A video on demand (VOD) gateway for enabling the delivery to subscriber equipment of VOD services from any of a plurality of incompatible and non-interoperable VOD systems, the VOD gateway comprising:
an asset gateway, for translating received lists of all currently available VOD assets from each of the plurality of incompatible and non-interoperable VOD systems, wherein each of the received lists is in a different protocol unique to each of said plurality of incompatible and non-interoperable VOD systems and aggregating said translated lists of all currently available VOD assets from each of the plurality of incompatible VOD systems to provide thereby a unified list of VOD assets; and
a transaction gateway, for conforming subscriber communications to the requirements of an appropriate VOD system, and for conforming VOD system communications to the requirements of an appropriate subscriber.

23. The VOD gateway of claim 22, wherein:
the asset gateway communicating with the transaction gateway via a transaction servlet; and
an asset data manager adapted to communicate with each asset management system via a respective interface program, the interface programs communicating with the asset data manager via asset management application programming interfaces (APIs).

24. The VOD gateway of claim 22, wherein each VOD system has associated with it a business management system (BMS), and wherein:
the transaction gateway communicating with each BMS via a respective BMS program, the BMS program communicating with the transaction gateway via transaction management APIs.

25. The VOD gateway of claim 24, further comprising:
a database to store one or both of client state information and client transaction information.

26. The VOD gateway of claim 22, wherein each VOD system has associated with it a VOD manager, the VOD gateway further comprising:
a session gateway communicating with each VOD manager via a respective session interface program, the session interface programs communicating with the session gateway via session interface APIs.

27. The VOD gateway of claim 26, wherein each VOD manager determines VOD channel parameters associated with a subscriber request, wherein:
the session gateway communicates VOD channel parameters toward subscriber equipment using one or both of Session Resource Management (SRM) and Session Set Up Protocol (SSP).
